(19) United States
(12) Patent Application Publication
(10) Pub. No.: US 2006/0082101 A1
(43) Pub. Date: Apr. 20, 2006

(54) One-piece trailer guide plate

(76) Inventor: Leondias Lloyd England, Monroe, LA (US)

Correspondence Address: Leondias L. England, 180 Buckhorn Bend Rd., Monroe, LA, 71202, US

(21) Appl. No.: 10/965,621

(22) Filed: Oct. 15, 2004

(51) Int. Cl. B60D 1/00

(52) U.S. Cl. 280/477

(57) ABSTRACT

A one piece trailer guide plate is designed to aid in aligning the trailer tongue directly over the ball, preventing damage to equipment and insuring user safety and convenience. The one piece trailer guide plate will eliminate the act of getting in and out of the tow vehicle in order to align the trailer tongue with the hitch ball. The one piece housing locking device of the trailer guide plate also eliminate the use of any tools. After alignment the one piece trailer guide plate can be easily removed with no permanent attachment remaining. Upon contact with the trailer tongue, the design of the one piece trailer guide plate directly positions the trailer tongue over the ball. Upon removal of the trailer guide plate, the trailer tongue can be lowered and secured to the ball.

### BACKGROUND OF THE INVENTION

### Field of the Invention

This invention relates to devices for the proper alignment of tow vehicles to trailers, more particularly to a (trailer guide plate) specifically in the art for the direct alignment of the hitch ball to the trailer tongue itself. In the preferred embodiment, the one piece trailer guide plate consists of a guide facing, ball housing, and stabilizer locks all combined in permanently-weld, one piece unit. All components are made of steel and welded together in the final embodiment of the invention.

The scope of this invention is to solve multiple problems associated with the alignment and connection of tow vehicles to trailer tongues and/or attachments. A common problem encountered when connecting trailers to tow vehicles is the proper aligning of the vehicle and trailer without damaging the surfaces of either in inadvertent contact. As a tow vehicle backs within the proximity of a trailer, the vehicle may progress too far and make contact with the trailer tongue, damaging the vehicle's bumper, license Plate, or tailgate. To avoid this damage, most users will back up to within a close range and leave the vehicle to check their alignment before backing further. In addition, the user may decide to try and pick up the trailer tongue and move the trailer itself into the desired position for attachment to the tow vehicle. This procedure creates the potential for personal injury such as back strains, muscle pulls, or even groin injury.

The advent of the one-piece trailer guide plate solves the aforementioned problems by giving the user the ability to continue backward motion toward the trailer tongue until the tow vehicle and trailer are properly aligned. By placing the ball housing of the trailer guide plate on the hitch ball, the guide facing forms a surface area allowing the trailer tongue to make contact with and be guided into exact proximity with the hitch ball. The stabilizer locks prevent twisting motion of the guide plate either to left or right, maintaining the appropriate surface area for the trailer tongue to make contact. Once the trailer tongue is in exact proximity with the hitch ball, the unit can be removed and stored, allowing the trailer tongue to be lowered and attached securely to the hitch ball.

### SUMMARY OF THE INVENTION

These and other objects of the invention are provided in a one piece trailer guide plate for alignment of a tow vehicle to a trailer. In the preferred embodiment, the one piece trailer guide plate system is characterized by a ball housing with a set of stabilizer attachments. The stabilizer locks prevent twisting motion of the guide plate either to the left or right. The guide plate housing is placed over the receiver ball to give permanent locking, preventing backward or forward movements. This will give the guide facing a surface area, allowing for the trailer tongue to make contact and be guided into exact proximity with the hitch ball.

The one piece trailer guide plate is an art used for convenience, portability, efficient storage, and safety. The guide plate is easy to attach to the tow vehicle, requiring no removal of the hitch ball for its installataion or for its use.

### BRIEF DESCRIPTION OF DRAWING

The invention will be better understood by reference to the accompanying drawings, wherein:

FIG. 1 is a perspective full view, of a one piece receiver style trailer guide plate, with the stabilizer components a preferred embodiment the guide plate system of this invention mounted on each side of the housing.

FIG. 2 is a perspective view partially in particularly illustrating a housing technique for securing the guide plate on the ball, illustrated in FIG. 1;

FIG. 3 is a basic front view of the guide plate and housing unit.

FIG. 4 is a perspective view of a typical guide plate face.

FIG. 5 is an overhead view of the guide plate, particularly illustrating the relative location of the housing locking component.

FIG. 6 is a perspective view of a set of stabilizer locks as illustrated in FIG. 1-3 and 5.

### DESCRIPTION OF THE PREFERRED EMBODIMENTS

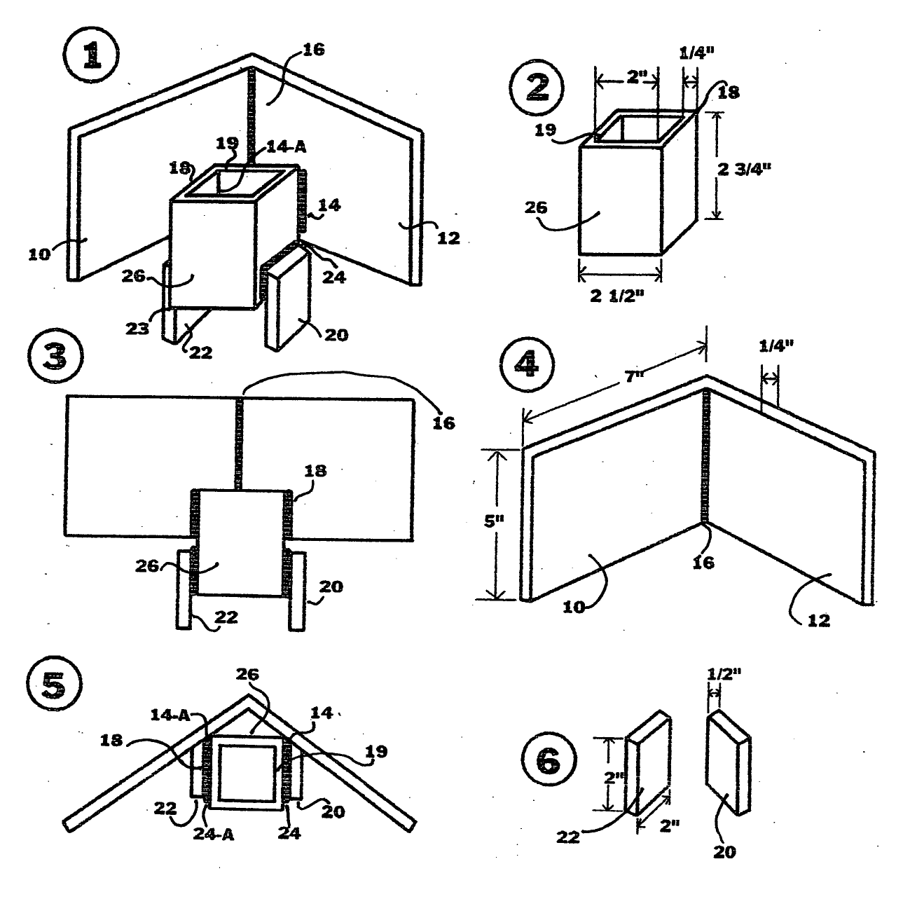

Now referring to the drawings, (FIG. 1), shows a mounting housing 26 which has an uppermost open surface in a two inch radius. The housing mount 26 placed over the ball (not illustrated) locks the guide facing 16, located at rear of housing 26, as illustrated in FIG. 1-5. The guide facing having a 14 inch surface in width, contacts at back surface 14-14A of the guide plate housing 26 to keep the guide plate facing 16 surface attached to the guide housing 26. The V-shaped plate 16 has double sidewalls 10 and 12 as illustrated in FIG. 1-5, ¼ inch thick with a facing of 0.7 inches in length on each side, protruding there from providing the V-shaped plate 16 with an overall distance of 0.14 inches. The surface 16 is 0.90 degree V-shape attached to the back surface 14-14A of the housing 26, giving a quality and powerful degree of strength, for forcibly impact of the trailer coupling (not illustrated).

As further illustrated in (FIG. 2), the guide housing 26. Provided with an inside diameter of 2 inches 19, which is noticeably smaller in diameter than the diameter of the outside wall 18. The outside surface 18, is substantially square in shape to mate with the V-Shape surface 16, as illustrated in FIG. 3. Referring to (FIG. 5 and 6) of the drawings, in another embodiment of the one piece guide plate FIG. 1 of this invention a right stabilizer 20 FIG. 6 having the same construction as the stabilizer of the left side 22 of FIG. 6 (corresponding to reference numeral 26 of FIG. 5) as the right stabilizer 20 connects in communication with the left side of housing 26, to connector 24 as illustrated, as the left stabilizer 22 connects in communication with the right side of housing 26, to connector 24A as illustrated in FIG. 5 with 24 and 24A being a permanent weld.

It will be appreciated by those skilled in the art that the one piece trailer guide plate of this invention provides a housing for guide support to eliminate the need to undo the receiver ball in order for the guide plate to be mounted or for its usage. Referring again to FIG. 1 and 2 it will be further appreciated that the housing 26 and the stabilizers 20 and 22 are appreciated and were by design to eliminate the use of any said tool to operate.

Having thus described my invention, what is claimed is.

1. A hollow housing locking device containing and comprising;
(a) Two identical locking jackets, each being integral metal structure Fabricated of steel material and having an extending flat sidewall, a Substantially flat and narrow bottom.
(b) Each locking stabilizer jacket, whereby are attached to and contained for and residing to each side of the housing locking device.
(c) When the two jackets are brought together with close fitting contact with the exterior surfaces of the sidewalls of the housing, the bottom of the guide plate housing is then locked with permanent weld to sidewall of stabilizer jackets, giving said jackets locking support.

2. The housing of claim 1 whereas the exterior top surface of the sidewall of said housing, is adjacent to outwardly flared flat surface of guide face with a permanent weld.

3. The housing of claim 1 where the v-shaped face is provided with a 5 inch engaging area defining the open upper extremity and adapted to and connected to the top and rear side of housing locking device for support.
This claim is directed toward and specifically to a One Piece Housing locking device. The use of the One Piece unit eliminates removal of the ball hitch in order to use the unit.
